(19) United States
(12) Patent Application Publication
(10) Pub. No.: US 2020/0375399 A1
(43) Pub. Date: Dec. 3, 2020

(54) Grinding Device In Combination With An Igniter That Is Chargeable Via A USB Port

(71) Applicants: Doron Ben Haim, Ra'anana (IL); Jack Cohen, Ra'anana (IL)

(72) Inventors: Doron Ben Haim, Ra'anana (IL); Jack Cohen, Ra'anana (IL)

(21) Appl. No.: 16/424,244

(22) Filed: May 28, 2019

(51) Int. Cl. A47J 42/32; F23Q 7/16

(52) U.S. Cl. CPC A47J 42/32; F23Q 7/16

(57) ABSTRACT

The present invention relates to herb grinding devices for grinding herbs and other plant matter into particulates, and more particularly, to an herb grinding device having a chargeable igniter or chargeable lighter. The herein disclosed device provides a combination grinding device and igniter (or lighter) so that a user may grind plant matter into smokeable and/or vaporizable particulates and then utilize the very same device to light or ignite the smokeable and/or vaporizable particulates so as to consume the plant matter efficiently. In certain embodiments, the igniter assembly may include a flameless lighter such as a coil lighter and may further include a port for receiving electrical charge from an external source to power to igniter. In an exemplary embodiment, the igniter assembly includes a rotatable lid for removably covering the igniter when the igniter is not in use.

### BRIEF DESCRIPTION OF THE INVENTION

The present invention relates to herb grinding devices for grinding herbs and other plant matter into particulates, and more particularly, to an herb grinding device having a chargeable igniter or chargeable lighter. The herein disclosed device provides a combination grinding device and igniter (or lighter) so that a user may grind plant matter into smokeable and/or vaporizable particulates and then utilize the very same device to light or ignite the smokeable and/or vaporizable particulates so as to consume the plant matter efficiently.

An exemplary embodiment of the herein disclosed device for grinding dried plant matter comprises a grinding assembly for grinding dried plant matter into particulates and an igniter assembly having an igniter for igniting the particulates, wherein the grinding assembly and the igniter assembly interlock to form a contiguous apparatus. The term interlock is used herein to describe the components comprising the grinding assembly fitting together or otherwise physically combining with the components comprising the igniter assembly to form a contiguous device that may be held and manipulated by a user using his or her hands.

In certain embodiments of the present invention, the igniter assembly may include a flameless lighter such as a coil lighter. In certain alternative embodiments, the igniter assembly may further include a port for receiving electrical charge from an external source to power to igniter (or to power a battery that powers the igniter). In an exemplary embodiment, the igniter assembly of the herein disclosed grinding device includes a rotatable lid for removably covering the igniter when the igniter is not in use. For example, when a user wishes to initiate use of the built-in igniter, the user rotates the igniter lid to expose the coil of the flameless coil igniter. The igniter assembly may also include a safety feature (or a security feature) that can automatically turn off the igniter after a predetermined time period of use has expired; for example, the igniter assembly may automatically shut off the coil lighter after 10 seconds of use.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

The present invention relates to herb grinding devices, and more particularly, to an herb grinding device having a chargeable igniter or chargeable lighter.

An herb grinding device is a mechanical device for pulverizing dried herbs, spices, tobacco, and other dried plants into particulates. Grinding the herb (or other plant matter) into particulates allows for the herb or other plant matter to be used in cooking or for the herb or other plant matter to be more readily smoked or vaporized (or vaped). Herb grinding devices can be either manual or electronic. Most manual grinding devices include a plurality of cooperating tiers wherein each tier may have protruding pegs or points that pulverize the herb or other plant matter when the tiers are moved relative to one another.

A lighter is a portable igniting device used to create a flame and/or heat that may be used to ignite and/or vaporize a variety of combustible and/or vaporizable materials such as dried herbs, cigarettes, cigars, gas stoves, fireworks, tobacco, and other plant matter. A lighter may be referred to as an igniting device, an igniter, or a device for igniting materials. Many types of lighters or igniting devices are known, including naphtha based lighters, butane lighters, jet lighters, electric arc lighters, automobile lighters, and flameless lighters such as coil lighters that utilize an enclosed heating element which may be heated until it glows and then used to ignite combustible and/or vaporizable materials.

It would be advantageous to combine an herb grinding device with a portable lighter or igniting device so that a user may grind dried plant matter into a smokeable and/or vaporizable particulate and then utilize the very same device to light or ignite the smokeable and/or vaporizable particulate in a separate smoking or vaporizing device. Heretofore, a device combining a grinding device for grinding plant matter into particulate and a flameless lighter or igniting device is unknown and unavailable in the marketplace.

### BRIEF DESCRIPTION OF THE SEVERAL VIEWS OF THE DRAWING

FIG. 1 illustrates front views of a first exemplary embodiment of a grinding device in combination with an igniter and a second exemplary embodiment of a grinding device in combination with an igniter, in accordance with the present invention;

FIG. 2 illustrates an isometric view of an exemplary embodiment of grinding device in combination with an igniter, in accordance with the present invention;

FIG. 3 illustrates a view of an exemplary embodiment of grinding device in combination with an igniter wherein a user has rotated a rotatable igniter cover to demonstrate an igniter in use, in accordance with the present invention;

FIG. 4 illustrates an exploded view demonstrating exemplary embodiments of a plurality of grinding components (viewing a first side of the plurality of grinding components) in a first exemplary embodiment of a grinding device in combination with an igniter and a second exemplary embodiment of a grinding device in combination with an igniter, in accordance with the present invention;

FIG. 5 illustrates an exploded view demonstrating exemplary embodiments of a plurality of grinding components (viewing a second side of the plurality of grinding components) in a first exemplary embodiment of a grinding device in combination with an igniter and a second exemplary embodiment of a grinding device in combination with an igniter, in accordance with the present invention;

FIG. 6 illustrates isometric and top-down views of several alternative embodiments of the herein disclosed grinding device in combination with an igniter, in accordance with the present invention.

### DETAILED DESCRIPTION OF THE INVENTION

The herein disclosed device provides a combination grinding device and igniter (or lighter) so that a user may grind plant matter into smokeable and/or vaporizable particulates and then utilize the very same device to light or ignite the smokeable and/or vaporizable particulates so as to consume the plant matter efficiently.

An exemplary embodiment of the herein disclosed device for grinding dried plant matter comprises a grinding assembly for grinding dried plant matter into particulates and an igniter assembly having an igniter for igniting the particulates, wherein the grinding assembly and the igniter assembly interlock to form a contiguous apparatus.

The term interlock is used throughout this specification to describe the components comprising the grinding assembly fitting together or otherwise physically combining with the components comprising the igniter assembly to form a contiguous device that may be held and manipulated by a user using his or her hands. One or more of the components of the herein disclosed grinding device may be sized so as to physically fit (or interlock, or snap, or inter-fit) together in a matter that is not permanent and is not secured by a fastener, but nevertheless is secure and stable during use due to the configuration of inter-fitting parts. In this way, the overall device combining the grinding assembly and the igniting assembly may be referred to as a contiguous apparatus.

The term plant matter (or dried plant matter) is used throughout this specification to refer generally to matter that may be ground into particulates using a grinding device. The term plant matter is intended to include dried herbs, spices, tobacco, marijuana (medicinal or recreational, dried or concentrated), and any other substance (organic or inorganic) that may be ground for use as a combustible or to be vaporized, including cooking ingredients and other foods.

An ideal embodiment of the herein disclosed device for grinding dried plant matter comprises a grinding assembly for grinding dried plant matter into particulates and an igniter assembly having an igniter for igniting the particulates; wherein the grinding assembly and the igniter assembly interlock to form a contiguous apparatus; wherein the grinding assembly includes a first grinding tier having a plurality of protruding pegs, a second grinding tier having a plurality of protruding pegs, and a grinding assembly lid; wherein the igniter assembly includes a USB port for receiving an electrical charge from an external power source, a flameless coil igniter, and a rotatable igniter lid for removably covering the igniter when the igniter is not in use.

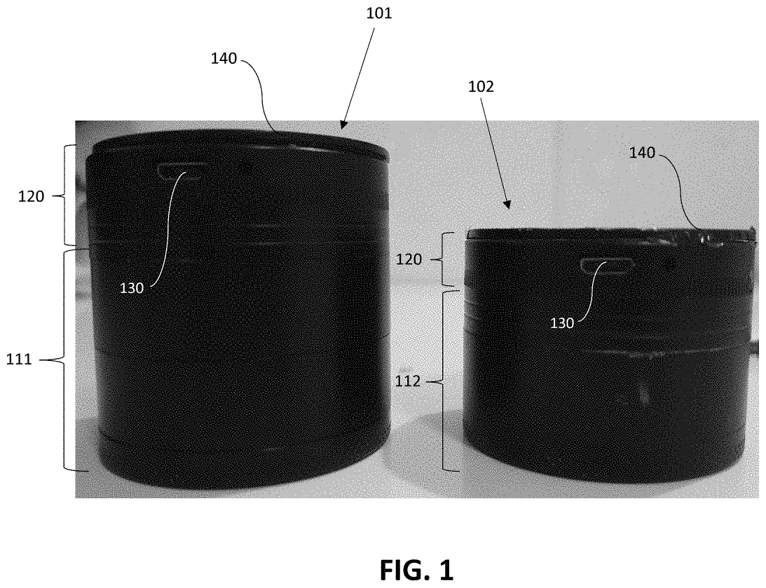

Referring to FIG. 1, a front view for two differing embodiments of the herein disclosed grinding device are shown. Grinding device 101 is an exemplary embodiment of the present invention having grinding assembly 111, igniter assembly 120, charging port 130, and rotatable igniter lid 140. Grinding assembly 111 interlocks (or otherwise attaching to or inter-fitting with) with igniter assembly 120 to form a contiguous apparatus that may be held in a user's hand.

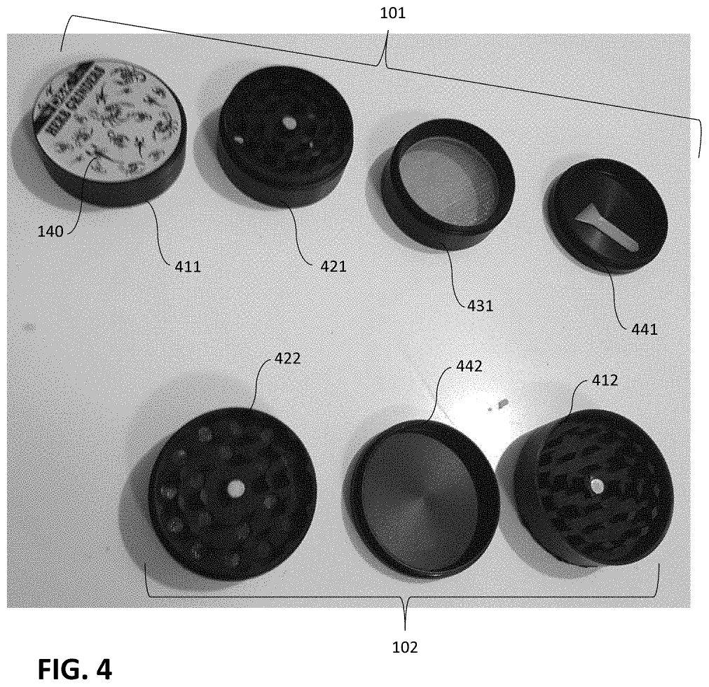

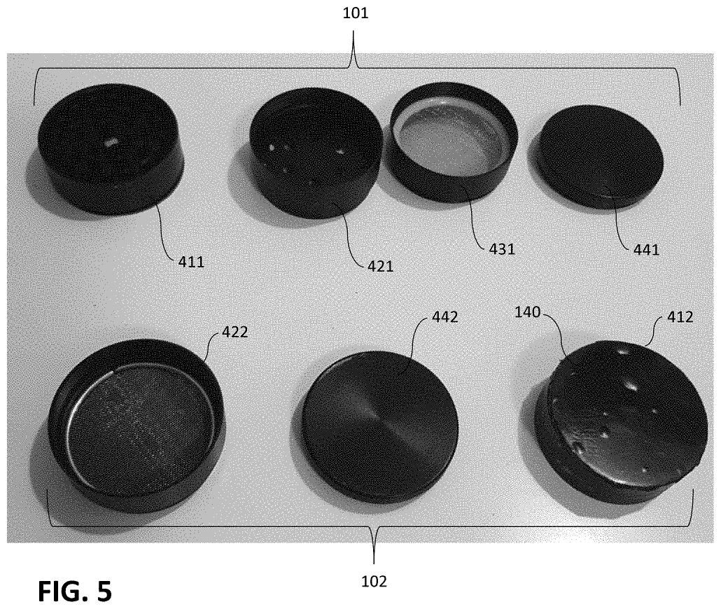

Grinding device 102 is a second exemplary embodiment of the present invention having grinding assembly 112 (which may differ from grinding assembly 111—see FIG. 4 and FIG. 5 demonstrating two exemplary embodiments of the herein disclosed grinding assembly of a grinding device in combination with an igniter that may chargeable via a USB port), interlocking (or otherwise attaching to or inter-fitting with) igniter assembly 120, charging port 130, and rotatable igniter lid 140.

Charging port 130 may be any type of port capable of receiving electrical power (or receiving an electrical power charge) for powering the igniter assembly of the herein disclosed grinding device. In a preferred embodiment, charging port 130 is a USB charging port. Alternatively, charging port 130 may be a USB-mini port, a USB-micro port, a USB-A port, a USB-B port, a USB-C port, a USB 3 port, or any other type of port for receiving a charge including receiving any type of power cable including an HDMI cable, a coaxial cable, or a firewire cable.

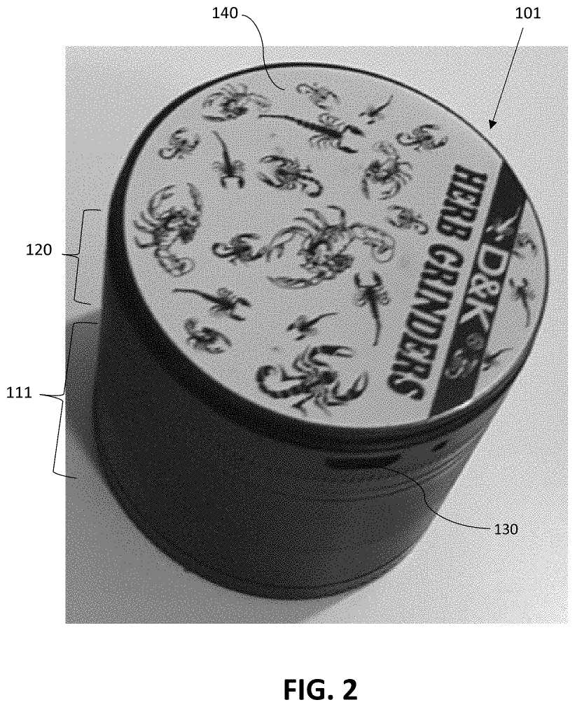

Referring now to FIG. 2, an isometric view of an exemplary embodiment of the herein disclosed grinding device is shown. Grinding device 101 includes grinding assembly 111, igniter assembly 120, charging port 130, and rotatable igniter lid 140.

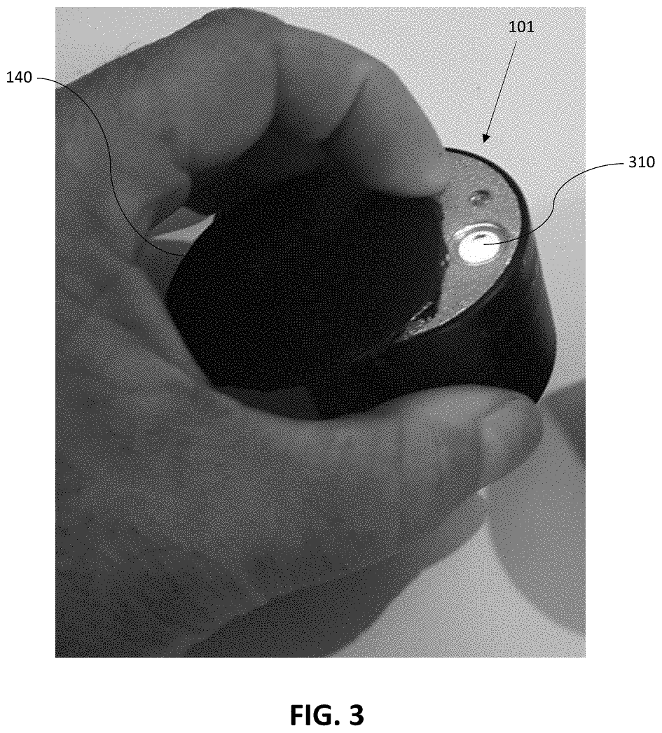

FIG. 3 illustrates an exemplary embodiment of the functionality of rotatable igniter lid 140 during use. When a user wishes to use the igniter of the herein disclosed grinding device, the user rotates rotatable igniter lid 140 to expose igniter 310. Rotatable igniter lid 140 may be any type of lid, covering, or cap capable of covering the entirety of the upper surface of igniter assembly 120 (or the entirety of the upper surface of grinder device 101). Alternatively, rotatable igniter lid 140 may only cover a portion of the upper surface of grinding device 101—in this alternative case, it may be enough to cover the igniter of igniter assembly 120. In an preferred embodiment, rotatable igniter lid 140 is a rigid disk formed of a plastic material and is rotatably attached to, or part of, igniter assembly 120. Rotatable igniter lid 140 may attach at an off-center point of the igniter assembly so that rotatable igniter lid 140 rotates about the off-center point and thus reveals a portion of the igniter assembly when the rotatable igniter lid 140 is rotated.

Igniter 310 may be any type of lighter or igniter capable of igniting or vaporizing particulates created by grinding plant matter. For example, igniter 310 may be a naphtha based lighter, a butane lighter, a jet lighter, an electric arc lighter, an automobile lighter, a metal match-type lighter or a flameless lighter such as a coil lighter that utilizes an enclosed heating element which may be heated until it glows and then used to ignite combustible and/or vaporizable materials. In a preferred embodiment, igniter 310 is a flameless coil lighter that may receive power via charging port 130. In an alternative embodiment, igniter 310 is a metal match-type lighter that includes a metal matchstick that is stored in a recessed compartment formed by either the grinder assembly or the igniter assembly. In such an embodiment, the recessed compartment may be configured to store a cache of liquid lighter-fluid.

Igniter assembly 120 may include one or more safety and/or security features that can control operation of igniter 310. For example, igniter assembly 120 may include a safety feature that can shut off igniter 120 after a predetermined period of time has elapsed. In this example, igniter 120 may be a coil lighter and igniter assembly 120 may include a controller to shut down or turned off the coil lighter after 10 seconds of continuous use or continuous operation.

Referring to FIG. 4 and FIG. 5, exploded views of two exemplary embodiments of the grinding assembly of the herein disclosed grinding device are shown. FIG. 4 shows a first side of each component and FIG. 5 shows a reverse side of the same components. The components are shown to demonstrate exemplary embodiments of components that may be used for the grinding assembly, but those skilled in the art will recognize that any type or configuration of the grinder assembly may be utilized in combination with a chargeable igniter to create the present invention, and all such types or configurations of the grinder assembly are intended to be included herein.

Exemplary embodiment 101 of the grinding device may include various components as part of grinding assembly 111. For example, the grinding device may include first grinding tier 411 having a plurality of protruding pegs, second grinding tier 421 having a plurality of protruding pegs, sifting tier 431 having a mesh screen for sifting particulates or partially ground plant matter, and grinding assembly lid 441.

Exemplary embodiment 102 of the grinding device may include various components as part of grinding assembly 112. For example, the grinding device may include first grinding tier 412 having a plurality of protruding pegs, second grinding tier 422 having a plurality of protruding pegs and a built-in sifting screen, and grinding assembly lid 442.

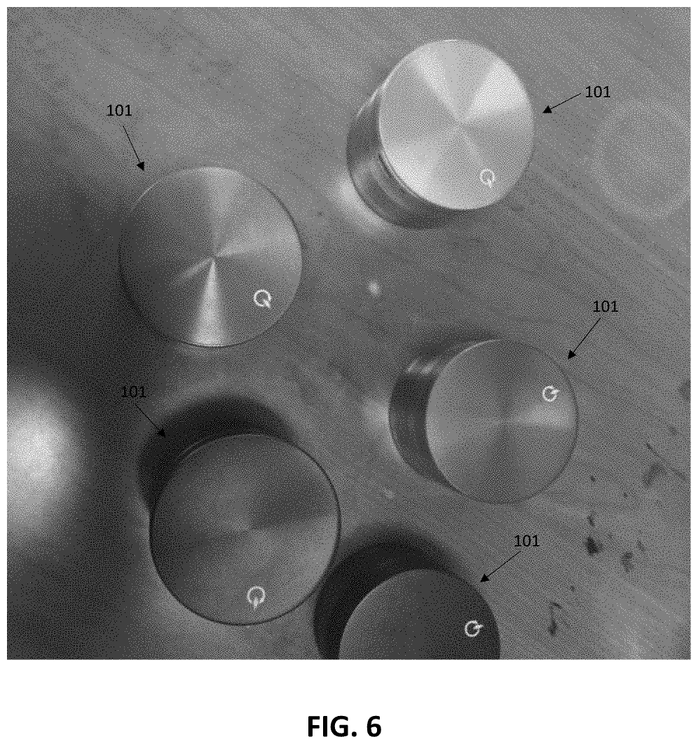

Referring to FIG. 6, several iterations of an alternative embodiment of the herein disclosed grinding device in combination with an igniter that is chargeable via a port for receiving a charge from an external power source are shown from a top-down view. As seen in FIG. 6 and as described in this specification, the present invention may be formed in any color and of any size.

While the present invention has been illustrated and described herein in terms of a preferred embodiment and several alternatives, it is to be understood that the devices described herein can have a multitude of additional uses and applications. Accordingly, the invention should not be limited to just the particular description and various drawing figures contained in this specification that merely illustrate a preferred embodiment and application of the principles of the invention

What is claimed is:

1. A device for grinding dried plant matter, comprising:
a grinding assembly for grinding dried plant matter into particulates; and
an igniter assembly having an igniter for igniting the particulates;
wherein the grinding assembly and the igniter assembly interlock to form a contiguous apparatus.

2. The device for grinding dried plant matter as recited in claim 1, wherein the igniter is a flameless lighter.

3. The device for grinding dried plant matter as recited in claim 1, wherein the igniter is a coil lighter.

4. The device for grinding dried plant matter as recited in claim 3, wherein the igniter assembly includes a USB port for receiving an electrical charge to power the igniter.

5. The device for grinding dried plant matter as recited in claim 1, wherein the igniter assembly includes a USB port for receiving an electrical charge to power the igniter.

6. The device for grinding dried plant matter as recited in claim 1, wherein the igniter assembly includes a port for receiving an electrical charge from an external power source.

7. The device for grinding dried plant matter as recited in claim 6, wherein the grinding assembly includes a first grinding tier having a plurality of protruding pegs, a second grinding tier having a plurality of protruding pegs, and a grinding assembly lid.

8. The device for grinding dried plant matter as recited in claim 7, wherein the grinding assembly further includes a sifting tier having a mesh screen for sifting particulates.

9. The device for grinding dried plant matter as recited in claim 7, wherein the igniter assembly includes a rotatable igniter lid for removably covering the igniter when the igniter is not in use.

10. The device for grinding dried plant matter as recited in claim 6, wherein the igniter assembly includes a rotatable igniter lid for removably covering the igniter when the igniter is not in use.

11. The device for grinding dried plant matter as recited in claim 1, wherein the igniter assembly includes a controller for automatically turning off the igniter after a predetermined period of continuous use.

12. The device for grinding dried plant matter as recited in claim 1, wherein the igniter assembly includes one or more safety features for controlling operation of the igniter.

13. The device for grinding dried plant matter as recited in claim 1, wherein the igniter is a metal match-type lighter.

14. The device for grinding dried plant matter as recited in claim 1, wherein the igniter includes a metal matchstick and wherein the igniter assembly forms a recessed compartment for storing a cache of lighter fluid and for receiving the metal matchstick.

15. A device for grinding dried plant matter, comprising:
a grinding assembly for grinding dried plant matter into particulates, wherein the grinding assembly includes a first grinding tier having a plurality of protruding pegs, a second grinding tier having a plurality of protruding pegs, and a grinding assembly lid; and
an igniter assembly having an igniter for igniting the particulates, wherein the igniter assembly includes a port for receiving an electrical charge from an external power source and a rotatable igniter lid for removably covering the igniter when the igniter is not in use;
wherein the grinding assembly and the igniter assembly interlock to form a contiguous apparatus.

16. The device for grinding dried plant matter as recited in claim 15, wherein the igniter is a flameless lighter.

17. The device for grinding dried plant matter as recited in claim 15, wherein the igniter is a coil lighter.

18. The device for grinding dried plant matter as recited in claim 15, wherein the port is a USB port.

19. The device for grinding dried plant matter as recited in claim 15, wherein the igniter assembly includes a controller for automatically turning off the igniter after a predetermined period of continuous use.

20. The device for grinding dried plant matter as recited in claim 15, wherein the igniter is a metal match-type lighter.
